(19) United States
(12) Patent Application Publication
(10) Pub. No.: US 2003/0175203 A1
(43) Pub. Date: Sep. 18, 2003

(54) Curing of positive plates

(76) Inventors: Werner Nitsche, Lippstadt (DE); Norbert Lahme, Brilon (DE)

Correspondence Address: CANTOR COLBURN, LLP, 55 GRIFFIN ROAD SOUTH, BLOOMFIELD, CT, 06002

(21) Appl. No.: 10/258,389

(22) PCT Filed: Feb. 2, 2002
(86) PCT No.: PCT/EP02/01298

(30) Foreign Application Priority Data
Feb. 24, 2001 (EP) 01104662.0

(51) Int. Cl. H01M 4/56; H01M 4/04; C01G 21/02

(52) U.S. Cl. 423/619; 429/225

(57) ABSTRACT

The invention relates to a method for rapidly curing positive lead accumulator plates. According to said method, the plates are separated and treated with water vapour for a period of less than 3 hours. The method is characterised in that the curing takes place at environmental temperatures of above 60° C. and that the type of lead sulphates that form during the curing process is controlled. To achieve this for example, finely crystalline tetrabasic lead sulphates are formed by the addition of seed crystals and the formation of tetrabasic lead sulphates is prevented by the addition of an expander. The invention enables the entire curing process to be reduced in an advantageous manner to approximately 4 h, thus improving the cost-effectiveness of the method.

The invention refers to a process for curing positive plates in production of lead accumulators.

To this date, the manufacture of the positive plates and their curing occurs almost exclusively in a so-called batch process. Conventional methods require that the positive plates be treated with water vapor for several hours during curing, wherein the complete curing process can take up to several days. The products incurred continuously by a production process are first collected and then processed further in a batch unit. This costly and time intensive curing process stands in sharp contrast to the automated manufacturing processes and achievement of a continuous finished product flow of lead accumulators.

The conventional process requires the construction of plate storage between the individual processing steps. The installation and maintenance of such plate storage is cost intensive. Additionally, due to the long curing process, production flexibility is not given, since the manufacture of plates takes up a long time and the reaction time for type changes is not very fast or flexible. However, it is a necessary disadvantage to maintain a large number of various types in storage.

Another problem is that the conventional process for curing positive plates causes the formation of granular crystalline tetrabasic lead sulfates. During the following formation process of the active mass, the tetrabasic lead sulfates are also to be converted to lead dioxide. However, if the tetrabasic lead sulfates are present in the granular crystalline form, the conversion into the charged condition is associated with problems since it is very difficult to convert the granular crystalline tetrabasic lead sulfates electrochemically. There are state-of-the-art solution approaches, which cause largely small crystalline tetrabasic lead sulfate to be produced. Nevertheless, these methods require increased care and further exhibit the above described disadvantage that curing requires an extraordinarily long time of up to several days. Recent attempts to shorten the curing process resulted in the risk that the later electric battery characteristics would be substantially affected.

Therefore, this invention is based on the task of making a method for curing positive plates available, in which the positive plates can be produced in a continuous manufacturing process and in which the charging difficulties of the positive mass can be prevented.

These problems will be solved in that this invention provides a process for curing positive lead accumulator plates in which the plates are separated and treated with a water vapor for a time period of less than 3 hours, whereby the curing takes place at ambient temperatures of above 60° C. and the lead sulfates being developing during curing can be controlled.

The process according to this invention makes it possible for the water vapor treatment to be advantageously completed in only a few hours. This is especially the result of separating the plates for the curing process. With this invention, it is being proposed to separate the plates, at least during the water vapor treatment. That makes an advantageous optimal curing for each plate possible. The separation, and thus the isolation can, for example, be accomplished with the help of an climate-effective membrane.

The plate surfaces are covered by the membrane, wherein it consists of materials, which transport and store the moisture and, furthermore, protect the plate surface from direct air movements. This generates a microclimate directly on the plate surface where the temperature, moisture maintenance, and air movement can be exactly set and controlled. This membrane also ensures an advantageous separation distance between the surfaces of adjacent plates and thus an unimpeded air stream between the plates as well as the unobstructed development of the desired climatic conditions between the plates.

Battery separators in sheet or pocket form, for example, can be used here as climate-effective membranes. Here, for example, they can be made from a PE [polyester] film. They can, for example, also be equipped with silicic acid inclusions, which cause the PE film to develop hygroscopic characteristics.

The advantage of the important feature according to the invention is that the individually isolated plates provide for a more effective steaming of the individual plates. This speaks in favor of the fact that with the invented process the steaming time period can be substantially shortened and thus the entire curing process carried out in a few hours. The process according to this invention thus provides for an advantageous time saving in the curing process and enables better control of the lead sulfate development.

According to this invention, the curing process takes place at ambient temperatures of above 60° C. Ambient temperatures above 80° C. have proven to be especially advantageous for the process according to this invention. Nevertheless, lower temperatures can also be partially advantageous, since it is also possible to control the nature of the lead sulfate buildup through the temperature control. However, using temperatures of above 80° C. accelerates the curing process.

The water vapor process improves the adhesion between the active substance and the lattice. This is based essentially on the fact that it generates an alkaline environment with increased PbO buildup.

Preferably, positive plates with corrosion-resistant lattice alloys, for example, based on PbCa, PbSn, as well as soft lead would be used. Furthermore, the use of water vapor, according to this invention, will increase the speed of crystalline buildup for curing the paste.

The critical aspect of the invention is, furthermore, that the nature of the lead sulfate buildup during curing is controlled. This characteristic makes it possible in a beneficial manner that the process can be controlled in such a way that the formation of granulated crystalline tetrabasic lead sulfates is avoided. That, in turn, will advantageously bypass the danger of charging problems during the formation.

Overall, this invention makes it possible to shorten the curing of positive plates to approximately 4 hours. This enables a continuous production flow and, furthermore, enables a high rate of production flexibility to the extent that design changes will occur. The process according to this invention makes it possible in a beneficial manner to produce more plates in one production run due to the extraordinarily short completion time. This substantially increases plant production capacity. Under the process according to this invention there is no need for costly plate storage. Beyond that, labor-intensive operations can be foregone. The invented method makes the curing of positive plates in sets possible. Overall, the process according to this invention is extraordinarily economical due to its shorter time for production and because of the continuous production flow.

Two of the embodiments of the process according to this invention have proven to be especially advantageous in controlling the type of lead sulfate formation during the curing.

According to the first embodiment, the process for curing is controlled in such way that tetrabasic lead sulfates arise. In view of the fact that the formation of granulated crystalline tetrabasic lead sulfates is unfavorable, it is recommended to control the process in such way that essentially only small crystalline tetrabasic lead sulfates are formed.

Nucleation of the tetrabasic lead sulfates can be controlled, for example, through the amount of sulphuric acid in the paste. Thus it was shown, that with small quantities of sulphuric acid in the paste, the nucleation of tetrabasic lead sulfates is highly inhibited so that, after a curing time under water vapor of about 1 hour, mostly only tri-basic lead sulfates are generated.

It is, therefore, recommended that a tetrabasic lead sulfuric structure be obtained by using seed crystals. In this process, the size of the seed crystals should be kept in the range of a few μm, in order to avoid the formation of granular crystalline tetrabasic lead sulfates. The use of seed crystals, whose size is in the range of smaller than or equal to 1 μm, has been considered to be especially advantageous. Seed crystals of this size can, for example, be obtained from breaking larger crystals into smaller ones. Thus tetrabasic crystals, for example, from a precipitation reaction in an agitation triturator mill using the wet grinding process, can be reduced to the required size with sand as the grinding substance. These seed crystals can then be added to the positive paste.

Based on the small amounts of acid, a tetrabasic lead sulfate structure cannot be formed spontaneously and without control. Since, however, according to the present embodiment, seed crystals are introduced into the positive paste, the crystallization process on the seed crystals is made possible, wherein the introduced small crystal grains act as the center of crystallization. In an advantageous manner, the crystallization process can thus be controlled and accelerated since, based on the small amounts of acid, a tetrabasic lead sulfate crystal can only be formed where a seed crystal has been introduced whereas the seed crystal strongly accelerates the formation.

Thus the curing process can be advantageously controlled and greatly shortened. The control of the crystallization process achieves primarily that small crystalline tetrabasic lead sulfates are formed. Thus the charging attributes of the positive plate and also of the accumulator is improved.

Even when using larger sulphuric acid quantities in the positive paste, the introduction of seed crystals has its advantages since here also the formation of small crystalline tetrabasic lead sulfates is increased and accelerated.

Since the formation of the tetrabaic lead sulfates is greatly accelerated by the introduction of the seed crystals, the short curing times and the preferred formation of small crystalline tetrabasic lead sulfates are being enhanced.

According to the second embodiment, the process of curing will be controlled such that the formation of the tetrabasic lead sulfates will, at least in part, be prevented and the formation of tri-basic lead sulfates will be promoted. As described above, this can, for example, occur through the selection of the acid quantity in the paste.

It is known that in case of the negative plates, tri-basic lead sulfates are formed after the vapor treatment. Surprisingly, it has been shown that the expanding materials from the negative paste, the so-called expanders, prevent or, delay the formation of tetrabasic lead sulfates in the positive paste and thus promote the formation of tri-basic lead sulfates. Therefore, it is recommended to add an expander to the positive paste in order to prevent the formation of tetrabasic lead sulfates during the time of curing. Expanders are admixtures of organic or inorganic components.

The blocking of nucleation of tetrabasic lead sulfates by the expander occurs in dependence on its concentration. The quantity of expander admixtures is generally to be selected dependent on the vapor reaction time as well as the quantity of sulphuric acid in order to achieve the desired inhibition rate. These conditions can also influence the selection of the respective expander. Here, the addition of the lignin has shown to be advantageous. This could be, for example, lignin sulfonic acid or desulphonized sulfonic acid. Such substances are, for example, available under the name Vanisperse. Naturally, we could also use other lignin derivatives or ulmic acids.

Experiments with Vanisperse as expander have shown that already a small amount of an expanding material greatly reduces the percentage of the tetrabasic lead sulfates. Thus it has been shown, that an addition of as little as 0.05 Kg of the expanding material per 100 Kg of dust reduces the share of the tetrabasic lead sulfates in the lead sulfates that are formed to a total of approximately 20%. The addition of 0.1 Kg of expanding material per 100 Kg of dust actually resulted in a formation of less than 5% of tetrabasic lead sulfates. These tests show that already a small amount of the expanding material can almost completely inhibit the formation of tetrabasic lead sulfates so that predominantly tri-basic lead sulfates are being formed. Based on the tests, the least amount of expanding material that must be added in order to achieve a sufficient inhibition in the formation of tetra-basic lead sulfate is about 0.02 Kg to 0.2 Kg per 100 Kg of dust.

The use of lignins or, lignin derivates as expanders is also especially advantageous under the aspect that during the formation process, the lignins are destroyed by oxidation. Evidence is not possible to obtain from a formed battery and, consequently, the addition of lignin, or lignin derivates has no disadvantageous affects on the battery and no drawback characteristics are known. Already with a minute amount of a lignin derivative portion, an almost complete inhibition is apparent in the formation of tetrabasic lead sulfates.

Since the addition of lignin derivates can affect the paste consistency, it is further recommended to add NaOH and/or Na₂SO₄ to the paste. Thus we can advantageously control the firmness of the paste. At the same time, the amount of NaOH and/or Na₂SO₄ must be chosen such that the desired firmness is achieved. The addition of NaOH and/or Na₂SO₄ has no substantial affect on the impact of lignin derivates.

With this invention, it is recommended that the water vapor treatment be undertaken for less than 3 hours. Preferably, the steaming should take place for the period of about 1 hour. The time information should be interpreted only as a recommended value that can be varied in dependence on other conditions such as, for example, the amount and type of the added expanders as well as the amount of sulphuric acid in the paste. In this manner, short steaming time periods are entirely possible in the process according to this invention, but they are not a mandatory requirement.

Overall, it is possible, using the process from this invention, to complete the fast curing and drying of the positive plates within four hours. Here, at ambient temperatures of over 80° C. and high air humidity, the isolated plates will be treated with vapor for one hour. This is followed by the pre-drying process, in which the free lead in the pasty mass of the plates is reduced. The metal decomposition occurs preferably during a time period of two and one-half hours. Here, ambient temperatures of 50 to 80° C. are advantageous. The surrounding air flow and the temperature should, preferably, be matched in such way that the moisture content of 9-10% in the pastes slowly drops off to about 4%. This phase is followed by the final drying phase of about one-half of an hour. For this we set the temperature preferably at 80° C. and create a flow of air passing over the plates. Preferably, at least during the phase of final drying, the air stream should be arranged in a way that the air flows directly over the surface or, past the membranes.

The process, according to this invention, can be used especially in the production of starter batteries as well as in manufacture of positive tube plates for the purpose of reducing the formation time. These data with respect to areas of utilization are not limiting.

1. Process for curing positive lead accumulator plates, characterized in that the plates are isolated and treated with water vapor for a time period of less then 3 hours, wherein the curing takes place at ambient temperature of over 60° C. and the type of lead sulfates being formed is controlled.

2. Process according to claim 1, characterized in that the curing takes place at ambient temperatures of approximately 80° C. or more.

3. Process according to claim 1 or 2, characterized in that the treatment with water vapor takes place during a time period of approximately 1 hour.

4. Process according to one or more of claims 1 through 3, characterized in that isolation of the plates is accomplished by separation of the plates by use of a climate control membrane.

5. Process according to one or more of claims 1 through 4, characterized in that curing takes place in a continuous process.

6. Process according to one or more of claims 1 through 5, characterized in that the nucleation formation of tetrabasiclead sulfates is controlled by the amount of sulphuric acid in the paste.

7. Process according to one or more of claims 1 through 6, characterized in that a small amount of acid is added to the positive paste, wherein the added quantity is less than approximately 4-6 l of sulphuric acid in a density of 1.40 g/ml per 100 Kg of dust.

8. Process according to one or more of claims 1 through 7, characterized in that tetrabasic lead sulfate seed crystals are added to the positive paste, wherein the size of the seed crystal is in the range of a few μm.

9. Process according to one or more of claims 1 through 8, characterized in that the seed crystals with a size of crystals of less or equal to 1 μm are used.

10. Process according to one or more of claims 1 through 9, characterized in that the seed crystals of the required size are produced by crushing of the larger crystals.

11. Process according to one or more of claims 1 through 10, characterized in that the curing is controlled in such way that the formation of tetrabasic lead sulfates is essentially prevented and the formation of tri-basic lead sulfates is promoted.

12. Process according to one or more of claims 1 through 11, characterized in that admixtures are added to the positive paste, which then either delay and/or prevent the formation of the tetrabasiclead sulfates during the steaming process time period.

13. Process according to one or more of claims 1 through 12, characterized in that the added amount is selected in dependence on the steaming time as well as the amount of sulphuric acid in the paste.

14. Process according to one or more of claims 1 through 13, characterized in that, preferably lignin, a lignin derivate, and/or ulmic acid admixture is added to the positive paste as an expander.
